(19) United States
(12) Patent Application Publication
(10) Pub. No.: US 2022/0159914 A1
(43) Pub. Date: May 26, 2022

(54) TOP COVER AND PLANTER SYSTEM

(71) Applicants: Richard J Eisen, Boca Raton, FL (US); Eric Schneider, Delary Beach, FL (US)

(72) Inventors: Richard J Eisen, Boca Raton, FL (US); Eric Schneider, Delary Beach, FL (US)

(21) Appl. No.: 17/366,587

(22) Filed: Jul. 2, 2021

Related U.S. Application Data
(63) Continuation-in-part of application No. 17/100,854, filed on Nov. 21, 2020, now Pat. No. 11,083,145.

(51) Int. Cl. A01G 9/02; A01G 24/50

(52) U.S. Cl. CPC A01G 9/028; A01G 2009/003; A01G 24/50

(57) ABSTRACT

A top cover system includes a bag including a growing medium wherein a top side of the bag includes an opening to access the growing medium for growing at least one of a seed and plant, and a top cover including an opening for placement upon the top side of the bag wherein a perimeter and an area of the opening of the top cover is smaller than a perimeter and an area of the opening of the top side of the bag and a perimeter and an area of the top cover is larger than a perimeter and an area of the top side of the bag such that when the top cover is placed upon the top side of the bag, the top side of the bag and a portion of the opening of the top side of the bag cannot be seen and the opening of the top cover includes access to the growing medium for growing the at least one of a seed and plant.

### CROSS REFERENCE TO RELATED APPLICATIONS

This application is a continuation in part of U.S. patent application Ser. No. 17/100,854, filed Nov. 21, 2020, which is incorporated by reference herein in its entirety.

### FIELD OF THE INVENTION

The present invention relates generally to planters for the propagation of vegetation and, more particularly, to a top cover and planter system adapted to grow plants or seeds in a bag having a growing medium.

### BACKGROUND OF THE INVENTION

Many horticultural hobbyists and home gardeners use planters to propagate plants from seeds or seedlings. Some hobbyists bypass the use of planters and instead propagate plants from seeds or seedlings directly within a potting soil bag.

It is a known technique among some gardeners to grow plants using a soil bag as a substitute for a planter. They use a knife to cut out several drainage holes on the bottom of the potting soil bag and cut out a portion of the top of the bag for planting seeds to water and grow plants by using the soil bag as a makeshift planter. However there are several drawbacks to planting with this technique including soil and water seeping from the bottom of the soil bag, having to excessively handle the soil bag to manually cut holes on both sides, and the loss of visual aesthetic that otherwise may have been enjoyed with the use of a planter.

Accordingly, in light of the above, there is a strong need in the art for a planter adapted to grow plants or seeds in a bag having a growing medium.

### SUMMARY OF THE INVENTION

The present invention enables growing seeds and plants inside a bag of growing medium with a planter system. The present invention enables piercing the bottom of a bag of growing medium by dropping it onto one or more bag piercing elements attached to a planter. The present invention enables piercing and cutting the top of a bag of growing medium with the use of a novel bag hole cutter and other piercing and cutting methods.

The present invention enables the minimization of the handling of growing medium while collecting any excess soil and water within the planter. The present invention permits a user to quickly change and replace interchangeable decorative top covers that rest on top of the planter system. The present invention enables a novel visual aesthetic through the use of a planter and top cover system while growing seeds and plants from within a bag of growing medium. The present invention hides the bag of growing medium from view so an observer would have no knowledge that a plant was growing inside of the bag. The present invention eliminates the need for additional separate planting pots thereby conserving the environment and saving cost to a user. The present invention enables a multi-configuration top cover system the provides more choice to the user as to the shape and number of bag openings to cut out of the top side of the bag.

In general, in accordance with the present invention, a planter for a bag including a growing medium, the bag used for growing at least one of a seed and plant includes a base used for placement under the bag, and at least one bag piercing element attached to the base where each bag piercing element includes at least one opening for liquid drainage below the base and projects upwardly from the base.

In accordance with an aspect of the present invention, a bag hole cutter for piercing and cutting a hole in a bag including a growing medium includes a circular plate having a diameter, a handle attached to a top of the circular plate, and a top of a tubular side wall integrally formed to a bottom of the circular plate, the tubular side wall having the same diameter as the circular plate wherein a bottom of the tubular side wall includes a plurality of cutting teeth adapted to pierce and cut a hole in the bag including the growing medium upon twisting the handle of the bag hole cutter upon the bag including the growing medium.

In accordance with another aspect of the present invention, a top cover for a bag including a growing medium, the bag used for growing at least one of a seed and plant includes the top cover having at least one opening for placement over the bag and at least one bag piercing element attached to a bottom perimeter of each top cover opening adapted to pierce a top of the bag upon the placement over the bag.

In accordance with yet another aspect of the present invention, a method for growing at least one of a seed and plant inside a bag of growing medium includes dropping the bag upon at least one bag piercing element attached to a planter base where each bag piercing element includes at least one opening for liquid drainage below the planter base and projects upwardly from the planter base, cutting at least one hole in a top of the bag to expose the growing medium, planting the at least one of a seed and plant inside the growing medium, and watering the at least one of a seed and plant.

In accordance with an aspect of the present invention, a top cover system includes a bag including a growing medium wherein a top side of the bag includes an opening to access the growing medium for growing at least one of a seed and plant, and a top cover including an opening for placement upon the top side of the bag wherein a perimeter and an area of the opening of the top cover is smaller than a perimeter and an area of the opening of the top side of the bag and a perimeter and an area of the top cover is larger than a perimeter and an area of the top side of the bag such that when the top cover is placed upon the top side of the bag, the top side of the bag and a portion of the opening of the top side of the bag cannot be seen and the opening of the top cover includes access to the growing medium for growing the at least one of a seed and plant.

In accordance with another aspect of the present invention, a top cover system includes a bag including a growing medium, a first top cover including an opening for placement upon a top side of the bag wherein a perimeter and an area of the opening of the first top cover is of a first geometric shape, and a second top cover including one or more openings for placement upon the first top cover wherein a perimeter and an area of the one or more openings of the second top cover is of a second geometric shape and the perimeter and the area of the second top cover is substantially similar to the perimeter and the area of the opening of the first top cover enabling a user to choose between the first geometric shape or the second geometric shape to create one or more openings upon the top side of the bag such that the first top cover or the first top cover in combination with the second top cover regardless of the exercised geometric shape choice of the user when placed upon the top side of the bag hides from view the top side of the bag and a portion of the one or more openings of the top side of the bag and the opening of the first top cover or the one or more openings of the second top cover include access to the growing medium for growing the at least one of a seed and plant.

In accordance with yet another aspect of the present invention, a top cover system includes a bag including a growing medium, a first top cover including an opening for placement upon a top side of the bag, and a second top cover including one or more openings for placement upon the first top cover wherein a perimeter and an area of the second top cover is substantially similar to a perimeter and an area of the opening of the first top cover enabling a user to choose one or more shapes to create one or more openings upon the top side of the bag such that the first top cover or the first top cover in combination with the second top cover regardless of the exercised shape choice of the user when placed upon the top side of the bag hides from view the top side of the bag and a portion of the one or more openings of the top side of the bag and the opening of the first top cover or the one or more openings of the second top cover include access to the growing medium for growing the at least one of a seed and plant.

### BRIEF DESCRIPTION OF THE DRAWINGS

FIG. 1 is a perspective view of an example planter system in accordance with the present invention.

FIG. 2-A is a bottom view of a planter base in accordance with the present invention.

FIG. 2-B is a cross-section view of a planter system in accordance with the present invention.

FIG. 3-A is a cross-section view of an alternate planter system in accordance with the present invention.

FIG. 3-B is a side view of a planter base in accordance with the present invention.

FIG. 3-C is a cross-section view of an additional alternate planter system in accordance with the present invention.

FIG. 4 is a perspective view of a bag hole cutter in accordance with the present invention.

FIG. 5 is a front view of portions of a top cover in accordance with the present invention.

FIG. 6 is a front view of portions of a top cover to form multiple rows of one or more openings in accordance with the present invention.

FIG. 7-A is a prior art perspective view of a cut bag opening on the top side of a bag used for planting.

FIG. 7-B is a prior art perspective view of several cut bag holes on the top side of a bag used for planting.

FIG. 8-A is a perspective view of a top cover for accessing a bag opening while hiding the bag in accordance with the present invention.

FIG. 8-B is a perspective view of a top cover for accessing a plurality of bag holes while hiding the bag in accordance with the present invention.

FIG. 9 is a perspective view of a top cover system in accordance with the present invention.

### DETAILED DESCRIPTION OF THE INVENTION

The present invention will now be described with reference to the drawings, wherein like reference numerals are used to refer to like elements throughout.

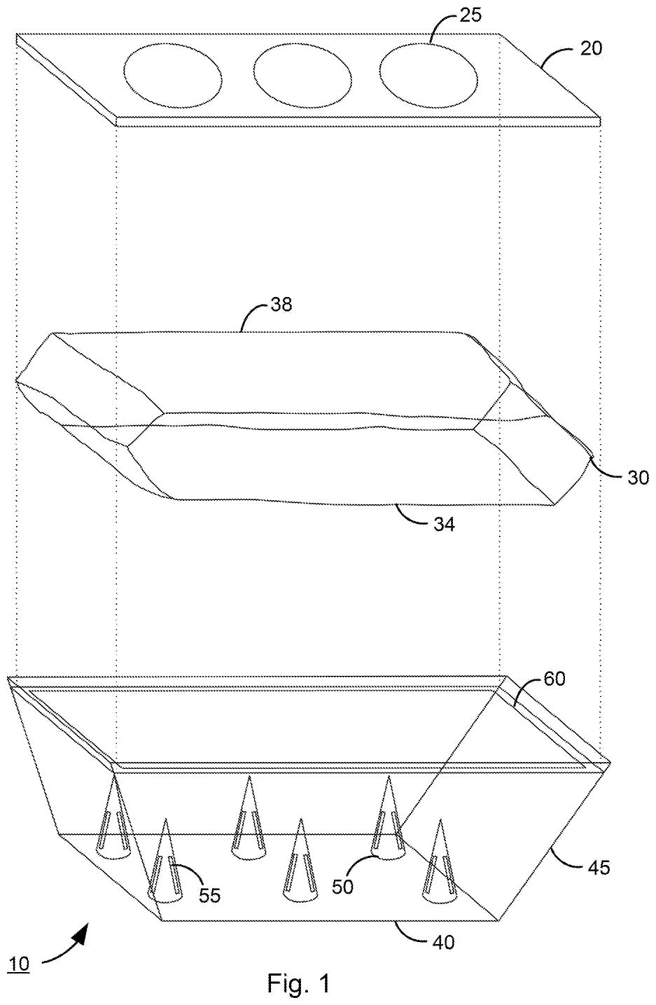

FIG. 1 is a perspective view of an example planter system in accordance with the present invention. A planter system 10 includes a top cover 20 with at least one opening 25 for one or more plants to grow through, a bag 30 filled with a growing medium, and a planter including a base 40 with side walls 45 upwardly extending away from the perimeter of the base 40 where the perimeter of the top of the side walls 45 is greater than the perimeter of the base 40. The planter base 40 further includes at least one bag piercing element 50 attached to the base 40 where each bag piercing element 50 includes at least one opening 55 for liquid drainage below the base 40 and projects upwardly from the base 40. The bag piercing element 50 can be integrally formed with the base 40 and rigidly attached thereto to form a unified planter assembly. The bag piercing element 50 is generally conical in shape having a sharp apex adapted to pierce the bottom 34 of the bag 30 and at least one drainage opening 55 positioned along a lateral surface of the bag piercing element 50.

With this planter system 10 the bag 30 filled with a growing medium can be dropped onto the one or more bag piercing elements 50 which would enable liquid from within the bag 30 to flow through the openings 55 of each bag piercing element 50 and drain underneath the planter base 40. The action of dropping the bag 30 also changes the shape and dimension of the bag 30 when it falls along the side walls 45 that are upwardly extending away from the perimeter of the base 40. As the bag 30 traverses along the sloping of each side wall, the growing medium shifts and compacts in a smaller area and gains in height. The top 38 of the bag 30 can then be opened to plant seeds positioned to grow through the openings 25 of the top cover 20 which can be placed above the bag 30 and rested upon an inner ledge 60 that is integrally formed along the inner perimeter of the side walls 45 positioned near the top of the side walls 45.

The planter system can be suited for those horticultural enthusiasts seeking to grow a bed of herbs and vegetables including plants that grow well together in a soil bed or single planter such as Mediterranean herbs by grouping rosemary, oregano, sage, and thyme together or by grouping basil, cilantro, tarragon, and parsley together, for example.

The bag 30 of growing medium can usually be found in a retailer's lawn and garden section as a sealed bag of potting soil or potting mix which include ingredients such as blend of perlite, peat moss, vermiculite, and fine bark. For instance, one popular bag 30 of growing medium is Miracle-Gro Garden Soil Vegetables and Herbs 1.5 cu ft which has dimensions of 24″×16″×5.6″ and weighs 48 lbs. The edges of the bag usually taper and some types of herbs need at least 7″ height of growing medium to foster ideal plant growth.

The planter base 40 can be made slightly smaller than the bag 30 of growing medium with a 22″ length and 14″ width so that when the bag 30 of growing medium is dropped upon the bag piercing elements the upwardly extending sidewalls can reshape the bag 30 dimensions by increasing the height to 7″ threshold to increase odds of ideal plant growth. Top cover openings 25 can range between 2″ diameter for areas to plant seeds and up to 4″ diameter for transplanting plants. Two rows of three or four top cover openings 25 are a reasonable number for the current planter base size example. The top cover serves a two-fold function; first as a mitigation to weed growth that can occur in open bed planter systems and to hide the bag 30 of growing medium such that upon looking at the planter system 10 an observer would have no idea that such plants are growing inside the original potting soil mix bag.

The bag piercing elements 50 can be spaced evenly apart with a 2″ diameter and 2″ height to its apex creating a sloped angle of roughly 63.5 degrees. The dimensions of planter base 40 and bag piercing elements 50 can be adjusted accordingly based on the different bag 30 dimensions and weight of products on the market. For instance, the sloped angle can be adjusted and range between forty degrees to eighty degrees by providing separate bag piercing element kits that can be screw-fitted into the planter base 40. Two rows of three to four bag piercing elements 50 are a reasonable number for the current planter base size example.

Adequate drainage is important especially if the planter is kept outdoors and exposed to rain. Herbs do not like overly wet soil making drainage an important consideration. A bag piercing element 50 with a steeper angle is preferred which makes it easier to pierce the bag 30 of growing medium when it is dropped upon the bag piercing element and provides more lateral surface area which in turn enable more surface area for more drainage openings to help the liquid drainage of say water to more easily pass through the bag 30 of growing medium.

Other popular sealed bags can come in 8 quart, 16 quart, 1 cu ft., or 2 cu ft. sizes. Different size planter bases can be made accordingly to accommodate similar results as presented in this instant invention. In general, the length and width of the base can be made between one to two inches smaller than the bag size. While most of the example dimensions shown above are predicated upon positioning the bag 30 of growing medium to achieve the lowest center of gravity, it can be appreciated by one of ordinary skill in the art to make the planter bases to taller and narrower to achieve similar results by dropping the bag 30 of growing medium with the highest center of gravity in a standing upright position. This might be applicable for transplanting a one or two larger plants that grow taller in an area with limited space.

The planter system 10 can also be made from the point of view of dropping the bag 30 of growing medium sideways into the planter base 40 similar in size of a windowsill box planter which is a very popular type of planter style that can run up to 24″ in length and have a one foot width and height, for example. In short, planter bases can be made to accommodate for the three different dimensions that the bag 30 of growing medium can be dropped and placed upon the bag piercing elements 50. Additionally, the present invention is not limited to pre-existing size bags and instead custom size bags 30 of growing medium can be made to more precisely fit any pre-existing planter base 40 dimensions.

The planter system 10 enables horticultural enthusiasts to plant in sensitive locations that they might otherwise not garden near like in a pool area. Most would be inhibited to do conventional gardening so close to a pool for concern of soil being too close and the risk of the area getting messier or dirtier or even some soil accidentally get in a swimming pool. With the new planter system 10 of the instant invention, the enthusiast would be more encouraged to garden closer to the pool area because the soil remains contained in the bag 30 of growing medium with a top cover providing both a pleasing visual aesthetic while hiding the bag such that guests would not even know the plants were growing in the original bag.

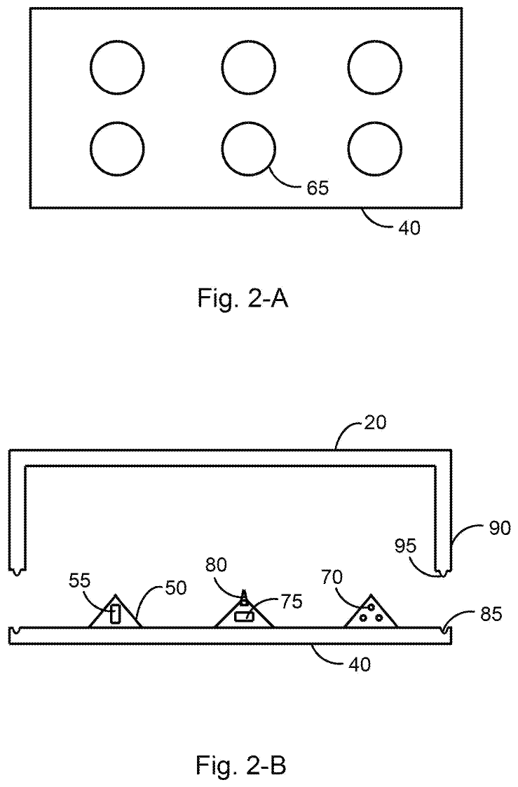

FIG. 2-A is a bottom view of a planter base in accordance with the present invention. The underside of a planter base 40 includes a base opening 65 that is positioned below each bag piercing element 50 (see FIG. 1) which allows for liquid drainage below the base 40 received from the one ore more openings 55 (see FIG. 1) of each bag piercing element 50. The base 40 includes a base opening 65 corresponding to each bag piercing element 50 adapted to receive and support each bag piercing element 50 and more specifically adapted to releasably attach by one of a press-fitting, snap-fitting, and screw-fitting (not shown) each bag piercing element 50 to each corresponding base opening 65. The base 40 can also include (not shown) channels that run across the bottom through the center of each base opening 65 so that when water flows to the bottom of the base, a capillary action can displace the water through the channels to better distribute drainage underneath the base 40.

FIG. 2-B is a cross-section view of a planter system in accordance with the present invention. The planter base 40 which includes a bag piercing element 50 having at least one opening 55 for liquid drainage below the base 40 also can include alternative bag piercing opening types such as circular openings 70 or horizontal openings 75. Further, a bag piercing element 50 can also include a sheared off opening near the apex or top of the bag piercing element 50 which can be used to receive an attachable and detachable bag piercing tip 80, that can be a material stronger than plastic such as metal and capable of a sharper piercing of the bottom 34 of the bag 30 of growing medium. Such a removable bag piercing tip 80 can be attached and detached by press-fitting, snap-fitting, and screw-fitting to the bag piercing element 50. In an alternative, the top cover 20 and side walls 90 can include rounded corners and edges or the top cover can be made longer and wider than the base such that the side walls 90 extend downwardly at less than ninety degree angles to snap or press fit into the planter base 40.

The planter base 40 can also include a recess or groove 85 formed along the perimeter of the planter base 40 and the top cover 20 can include downward extending walls 90 with a rib, tongue, or protrusion 95 formed along the perimeter of the bottom of the downward extending walls 90. The rib, tongue, or protrusion 95 is designed to press-fit or snap-fit into the recess or groove 85 to releasably attach/secure the top cover 20 and planter base 40 by creating a seal between them to form the planting system 10. Such techniques of further securing the top cover 20 to the inner ledge 60 (see FIG. 1) can be applied where the top cover can include protrusions near the corners and the inner ledge can include recesses or grooves that near the corners that line up to enable the top cover 20 protrusions to be press-fitted or snap-fitted into the inner ledge 60 recesses or grooves to releasably attach/secure the top cover 20 to the inner ledge 60.

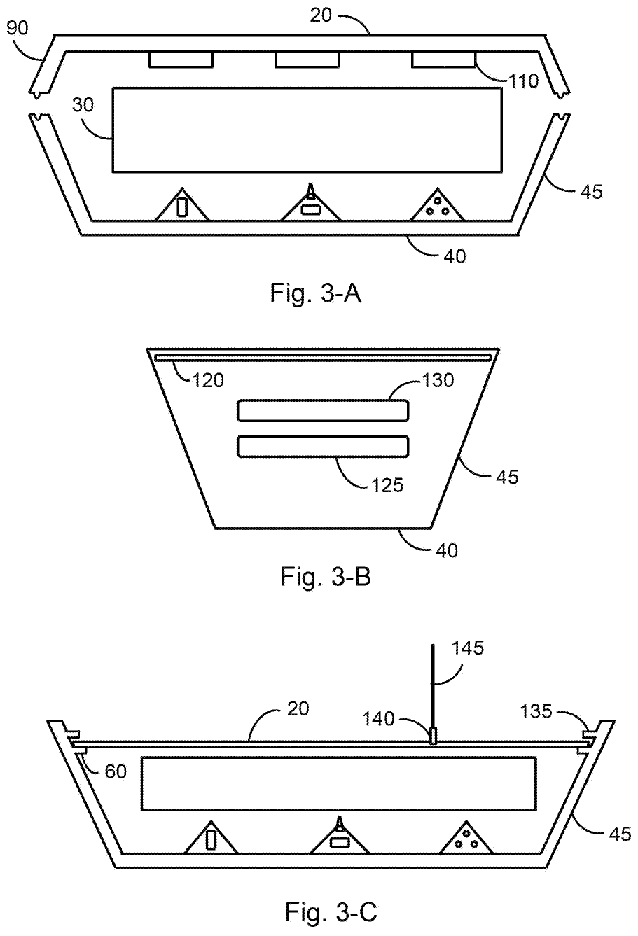

FIG. 3-A is a cross-section view of an alternate planter system in accordance with the present invention. A planter includes a top cover 20 with downwardly extending side walls 90 that are adapted to releasably attach by one of a press-fitting and snap-fitting upon the top of the side walls 45 upwardly extending away from the perimeter of the base 40. The perimeter of each top cover opening 25 includes a downwardly extending sharp lip 110 integrally formed with each top cover opening 25 and rigidly attached thereto, each sharp lip 110 adapted to pierce a top 38 of the bag 30 upon one of a press-fitting and snap-fitting the top cover 20 to the planter base 40 which enables access to the growing medium for growing at least one of a seed and plant.

FIG. 3-B is a side view of a planter base in accordance with the present invention. It illustrates one of an opposing pair of side walls 45 upwardly extending from the base 40 having a horizontal opening 120 traversing the width of each side wall 45 positioned near the intersection between an edge of the top cover and the side wall 45. The horizontal opening 120 is used to receive, give support, and hold in place at least a portion of a top cover that can be slid through the horizontal opening 120. A pair of wider openings are positioned a little above center of the side wall 45 including a lower opening 125 and upper opening 130 which form a handle for a user to lift up the planter base 40 with. These openings can also be used to air out water or smell from the bag 30 of growing medium or to have access to make side holes in the bag 30 without removing the top cover 20 in case a user chooses to create another path for water to flow out of the bag 30.

FIG. 3-C is a cross-section view of an additional alternate planter system in accordance with the present invention. In an alternate embodiment there is both a lower inner ledge 60 and an upper inner ledge 135 that are integrally formed along the inner perimeter of the side walls 45 positioned near the top of the side walls 45. The additional inner ledge can be used in conjunction with the horizontal opening 120 (see FIG. 3-B) traversing the width of each side wall 45 positioned near the intersection between an edge of the top cover and the side wall 45. This enables the top cover 20 to be slid through the horizontal opening 120 to rest and be secured between the lower inner ledge 60 and upper inner ledge 135. At least one trellis receptacle 140 can be upwardly extending from and integrally formed with a top of the top cover 20 and a trellis rod 145 can be adapted to releasably attach by one of a press-fitting, snap-fitting, and screw-fitting upon each trellis receptacle 140. The trellis receptacle can also be tubular and open ended and act as a guide to the trellis rod 145 which can be slid further down into the bag 30 of growing medium to provide further anchoring and support to better stand up to high wind environments if necessary.

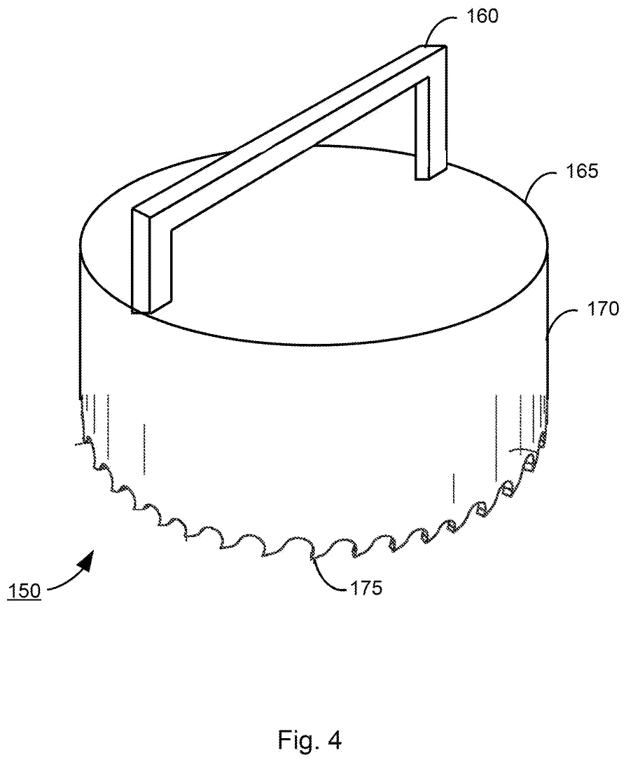

FIG. 4 is a perspective view of an example bag hole cutter in accordance with the present invention. A bag hole cutter 150 can include a handle 160 attached to a top of a circular plate 165 having an integrally formed tubular side wall 170 attached to the bottom of the circular plate 165 where the tubular side wall 170 and circular plate 165 share the same diameter and where the bottom of the tubular side wall 170 includes a plurality of cutting teeth 175. The bag hole cutter 150 can be placed inside each opening 25 of the top cover 20 that is placed on top 38 of the bag 30 of growing medium. A user can twist turn the bag hole cutter 150 to pierce and cut a hole in the top 38 of the bag 30 of growing medium.

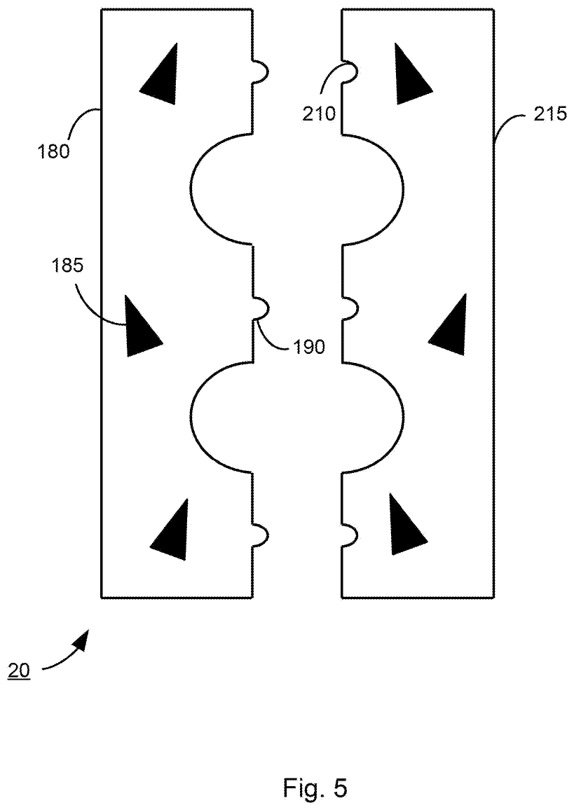

FIG. 5 is a front view of portions of a top cover in accordance with the present invention. A first removable interchangeable planar surface insert 180 having decorative elements 185 in this case with geometric figures includes at least one cut out (partial opening) of a first edge with a rib, tongue, or protrusion 190 adapted to slide through a first horizontal side wall opening 120 (see FIG. 3-B) and releasably attach by one of a snap-fitting or press-fitting into at least one cut out (partial opening) of a second edge with a recess or groove 210 of a second removable interchangeable decorative planar surface 215 insert adapted to slide through a second horizontal opposing side wall 120 (see FIG. 3-B) opening such that when each cut out of the first edge and each cut out of the second edge are fitted to form a top cover 20 having a single row of two openings 25 to access the growing medium 30 for growing the at least one a seed and plant. It is obvious to one of skill in the art that top cover portions can be designed to form one or more openings in a single row. The decorative elements can be customized by printing or silk screening personal images or to just about any image capable of being applied to the top cover portions (180, 215). Top cover portions can include an advertising element showing images of brand, logos, or sponsors, for example. Such top cover portions (180, 215) become particularly useful when a plant is already planted in the bag 30 of growing medium and a single top cover 20 cannot be fitted or placed on top of the plant. The top cover portions (180, 215) are attached and removed from each side of the plant to form the top cover opening 25 around the plant.

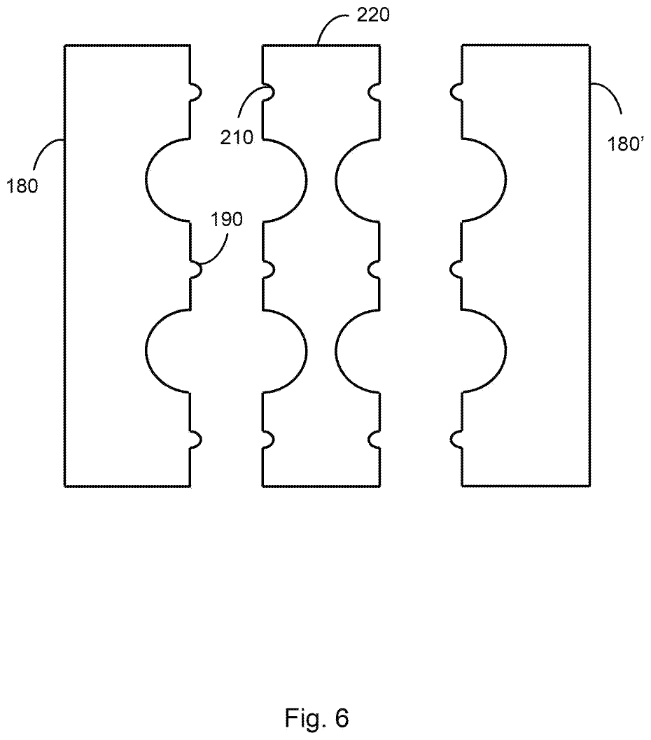

FIG. 6 is a front view of portions of a top cover to form multiple rows of one or more openings in accordance with the present invention. A first removable interchangeable planar surface insert 180 and a second removable interchangeable planar surface insert 180′ each include at least one cut out (partial opening) of top cover portion edge with one or more ribs, tongues, or protrusions 190. A third interchangeable planar surface insert 220 include at least one cut out (partial opening) on opposing insert edges along with one or more recesses or grooves 210 adapted to releasably attach by one of a snap-fitting or press-fitting into the one or more ribs, tongues, or protrusions 190 of the first removable interchangeable planar surface insert 180 and a second removable interchangeable planar surface insert 180′ to form two rows of one or more top cover openings.

The opening of a top of the bag can be adapted to receive a liquid used for growing the at least one of a seed and plant placed in the growing medium and drain the liquid through the one or more openings of the bag piercing element after the bag is pierced upon the placement of a bottom of the bag on top of each bag piercing element.

The planter can include an inner ledge integrally formed along an inner perimeter of the side walls that is slightly sloped or angled from each edge toward the center such that when top cover portions rest upon it, any water from rain or watering that lands on the top cover portions can roll inward to the formed top cover openings and drain inside of the bag of growing medium.

A plurality of planter bases can be stackable on top of each other due to the perimeter of the top of the side walls greater than the perimeter of the base and a plurality of top covers can be stackable on top of each other due to the perimeter of the bottom of top cover side walls greater than the perimeter of the top cover.

In one alternative, The planter can include a length and width of the base slightly smaller than a length and width of the bag which aids in shrinking the area of the bottom of the bag of growing medium when it is dropped upon the bag piercing elements and slides along the sloping side walls of the planter to change its shape. The planter can also include a length and width of the base greater than a length and width of the bag and a length and width of the top cover is greater than a length and width of the base.

At least one of the planter base, the top cover, and the bag hole cutter can be printed by a three dimensional printing process or molded by a process selected from a group consisting of a blow molding and injection molding process and the material of at least on of the planter base, top cover, and bag hole cutter is a polymer selected from a group consisting of a co-polymer, polystyrene, alkyl benzene, sulfonate (ABS), polyethylene, biodegradable resin, bioplastic, and polypropylene polymer. Materials can be made or pressed from molded pulp or fiber or any other known biodegradable material. The planter system 10 elements can also be made from other materials such as metal, wood, vinyl, or fiberglass, PVC, resin, clay, ceramic, and stone, for example.

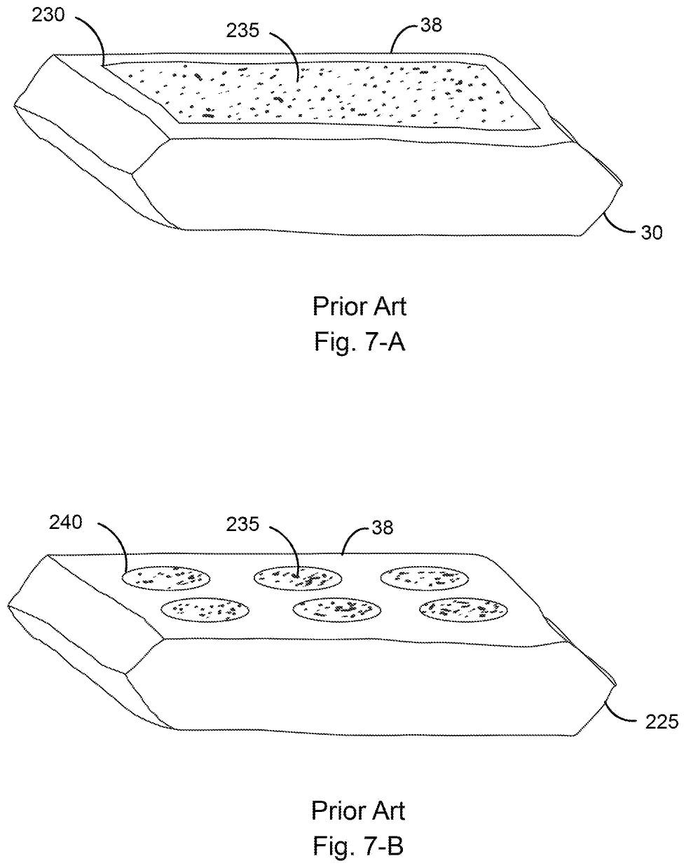

FIG. 7-A is a prior art perspective view of a cut bag opening on the top side of a bag used for planting. A top side 38 of a bag 30 includes a single rectangular bag opening 230 that reveals the growing medium 235 inside of the bag 30. FIG. 7-B is a prior art perspective view of several cut bag holes on the top side of a bag used for planting. A top side 38 of a bag 225 includes a plurality of circular bag openings 240 that reveal the growing medium 235 inside of the bag 225. It is common for some planting enthusiasts to grow directly from a potting mix soil bag by puncturing holes in the bottom side of the bag for drainage and cutting open the top side of the bag to access the growing medium for planting. The two main types of bag openings that planting enthusiasts choose to make to the top side of the bag are a single large rectangular cut to form a single opening 230 or a plurality of circular cuts (see FIG. 7-B) to form a plurality of openings 240. There are no solutions in the market place for hiding the bag from view while still enabling a planting enthusiast to have access to the growing medium inside of the bag via the cut out openings.

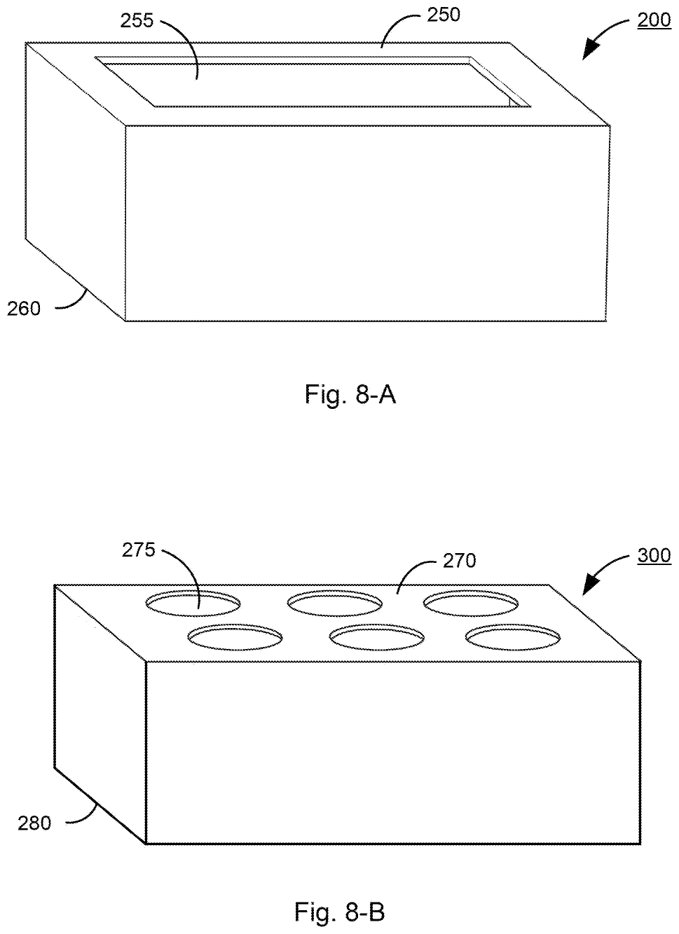

FIG. 8-A is a perspective view of a top cover for accessing a bag opening while hiding the bag in accordance with the present invention. A top cover system 200 includes a top cover surface 250 with a top cover opening 255, where the top cover surface 250 includes sidewalls 260 downwardly extending from a perimeter of the top cover surface 250. The height of the sidewalls 260 is higher than the height of the bag 30 (see FIG. 7-A), a perimeter and an area of the top cover surface 250 is larger than a perimeter and an area of the top side 38 of the bag 30 (see FIG. 7-A), and a perimeter and an area of the top cover opening 255 is smaller in size than a perimeter and an area of the bag opening 230 (see FIG. 7-A). The top cover system 200 can be placed over and around the bag 30, such that when placed, the bag is hidden but the growing medium 235 inside of the bag 30 can still be accessed for planting at least one of a seed and plant. In this embodiment, the top cover surface 250 is integrally formed with the downwardly extending sidewalls 260.

FIG. 8-B is a perspective view of a top cover for accessing a plurality of bag openings while hiding the bag in accordance with the present invention. A top cover system 300 includes a top cover surface 270 with a plurality of top cover openings 275, where the top cover surface 270 includes sidewalls 280 downwardly extending from a perimeter of the top cover surface 270. The height of the sidewalls 280 is higher than the height of the bag 225 (see FIG. 7-B), a perimeter and an area of the top cover surface 270 is larger than a perimeter and an area of the top side 38 of the bag 225 (see FIG. 7-B), and a perimeter and an area of each top cover opening 275 of the plurality of top cover openings is smaller in size than a perimeter and an area of each bag opening 240 of the plurality of bag openings (see FIG. 7-B). The top cover system 300 can be placed over and around the bag 225, such that when placed, the bag is hidden but the growing medium 235 inside of the bag 225 can still be accessed for planting at least one of a seed and plant. In this embodiment, the top cover surface 270 is integrally formed with the downwardly extending sidewalls 280.

The top cover shown in FIG. 8-A is a solution for hiding the bag while accessing the growing medium shown in prior art FIG. 7-A and the top cover shown in FIG. 8-B is a solution for hiding the bag while accessing the growing medium shown in prior art FIG. 7-B. The solution is dependent upon how the bag is cut to create at least one opening. There is another embodiment capable of multiple configuration to enable a single top cover system to apply independent of which way the at least one bag opening is cut.

The top cover system can include side walls downwardly extending from the perimeter of the top cover where a height of the side walls of the top cover is greater than a height of the bag laid on its side such that when the top cover including the side walls is placed upon the bag laid on its side, the bag cannot be seen. The side walls can be integrally formed with the top cover and rigidly attached thereto to form a unified top cover assembly or the side walls are adapted to releasably attach by one of a press-fitting and snap-fitting the side walls to the perimeter of the top cover. The top cover system can include a planter base where a perimeter and area of the planter base is greater than the perimeter and the area of the bag and further include side walls upwardly extending from the perimeter of the planter base where a height of the side walls of the planter base is greater than a height of the bag laid on its side such that when the bag is placed laid on its side inside the planter base including the side walls, a bottom side of the bag cannot be seen. Such planter base side walls can be integrally formed with the planter base and rigidly attached thereto to form a unified planter base assembly or the side walls can be adapted to releasably attach by one of a press-fitting and snap-fitting the side walls to the perimeter of the planter base. The perimeter of the top cover can be adapted to releasably attach by one of a press-fitting and snap-fitting the perimeter of the top cover to the side walls of the planter base such that when the bag is placed inside the planter base including the side walls and the perimeter of the top cover is attached to the side walls of the planter base, the bag cannot be seen.

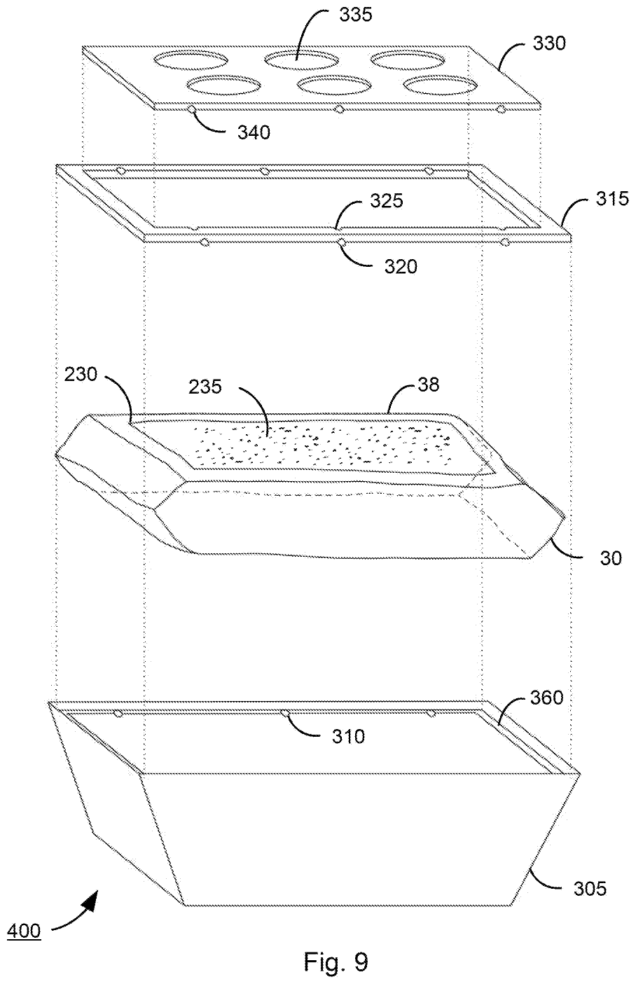

FIG. 9 is a perspective view of a top cover system in accordance with the present invention. The top cover system 400 can include any combination of a plurality of sidewalls 305 that can be integrally formed to one another or in the alternative each sidewall can be made separate and securely attached to one another to construct the plurality of sidewalls 305 where the height of the sidewalls is greater than the height of the bag 30 and a perimeter and an area defined by the sidewalls 305 are larger than the perimeter and the area of the bag 30. In one embodiment the plurality of sidewalls can include an inner ledge 360 that span an inner perimeter near the top of the sidewalls 305, the inner ledge 360 having recesses or grooves 310 placed along the ledge that are aligned to enable a first top cover 315 having protrusions 320 to be press-fitted or snap-fitted into the inner ledge 360 recesses or grooves 310 to releasably attach/secure the first top cover 315 to the inner ledge 360. When attached the top surface of the first top cover 315 is flush with the top edge of the sidewalls 305. The invention is not dependent upon the inner ledge 360. In an alternate embodiment (not shown), the top edge of each sidewall can include recesses or grooves that align up with the bottom surface of the first top cover having tongues or protrusions that can be press-fitted or snap-fitted to releasably attach/secure from one another.

The first top cover 315 looks similar to a picture frame where the inner perimeter and area of the first top cover 315 is smaller than the perimeter and the area of the rectangular bag opening 230. When the first top cover 315 is placed atop of the bag 30, the bag cannot be seen from above but the growing medium 235 is accessible to plant at least one of a seed and plant. When the bag 30 is placed inside of the sidewalls 305 and the first top cover 315 is attached to the sidewalls 305, the bag is completely hidden but yet the growing medium 235 is accessible to plant at least one of a seed and plant.

The bag 30 shown is similar to the prior art of FIG. 7-A. However, if the bag 225 similar to the prior art of FIG. 7-B were used in its place, the first top cover 315 would not be able to hide all portions of the top side of the bag 225 from view due to the plurality of bag openings 240. A second top cover 330 including a plurality of cover openings 335 can be used to solve this where the outer perimeter of the second top cover 330 is substantially similar in size to the inner perimeter of the first top cover 315. The second top cover 330 includes a plurality of distributively spaced protrusions 340 that align with a plurality of distributively spaced recesses 325 along the inner perimeter of the first top cover 315. This enables the second top cover 330 having protrusions 240 to be press-fitted or snap-fitted into the recesses 325 of the first top cover 315 to releasably attach/secure the second top cover 330 to the first top cover 315. By so doing, the remaining exposed portions of the bag 225 will become hidden from view. The multi-configuration aspect of a plurality of top cover surfaces enables the enthusiast to have more choice in what kind and how many openings to cut open on the top side of the bag. Whether it is a single bag opening of a first geometric shape such as a rectangle or multiple bag openings of a second geometric shape such as a plurality of holes or circles, additional top cover attachments can be made to accommodate any bag opening configuration.

The top cover system can include side walls downwardly extending from the perimeter of the first top cover wherein a height of the side walls of the first top cover is greater than a height of the bag laid on its side such that when the first top cover including the side walls is placed upon the bag laid on its side, the bag cannot be seen where the side walls can be integrally formed with the first top cover and rigidly attached thereto to form a unified top cover assembly or the side walls are adapted to releasably attach by one of a press-fitting and snap-fitting the side walls to the perimeter of the first top cover. The top cover system can further include a planter base where a perimeter and area of the planter base is greater than the perimeter and the area of the bag can include side walls upwardly extending from the perimeter of the planter base where a height of the side walls of the planter base is greater than a height of the bag laid on its side such that when the bag is placed laid on its side inside the planter base including the side walls, a bottom side of the bag cannot be seen. The side walls can be integrally formed with the planter base and rigidly attached thereto to form a unified planter base assembly or the side walls can be adapted to releasably attach by one of a press-fitting and snap-fitting the side walls to the perimeter of the planter base. The perimeter of the first top cover can be adapted to releasably attach by one of a press-fitting and snap-fitting the perimeter of the first top cover to the side walls of the planter base such that when the bag is placed inside the planter base including the side walls and the perimeter of the top cover is attached to the side walls of the planter base, the bag cannot be seen.

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a “means”) used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

What is claimed is:

1. A top cover system comprising:
a bag including a growing medium wherein a top side of the bag includes an opening to access the growing medium for growing at least one of a seed and plant; and,
a top cover including an opening for placement upon the top side of the bag wherein a perimeter and an area of the opening of the top cover is smaller than a perimeter and an area of the opening of the top side of the bag and a perimeter and an area of the top cover is larger than a perimeter and an area of the top side of the bag such that when the top cover is placed upon the top side of the bag, the top side of the bag and a portion of the opening of the top side of the bag cannot be seen and the opening of the top cover includes access to the growing medium for growing the at least one of a seed and plant.

2. The top cover system, as set forth in claim 1, further including side walls downwardly extending from the perimeter of the top cover wherein a height of the side walls of the top cover is greater than a height of the bag laid on its side such that when the top cover including the side walls is placed upon the bag laid on its side, the bag cannot be seen.

3. The top cover system, as set forth in claim 2, wherein the side walls are integrally formed with the top cover and rigidly attached thereto to form a unified top cover assembly.

4. The top cover system, as set forth in claim 2, wherein the side walls are adapted to releasably attach by one of a press-fitting and snap-fitting the side walls to the perimeter of the top cover.

5. The top cover system, as set forth in claim 1, further including a planter base wherein a perimeter and area of the planter base is greater than the perimeter and the area of the bag.

6. The top cover system, as set forth in claim 5, further including side walls upwardly extending from the perimeter of the planter base wherein a height of the side walls of the planter base is greater than a height of the bag laid on its side such that when the bag is placed laid on its side inside the planter base including the side walls, a bottom side of the bag cannot be seen.

7. The top cover system, as set forth in claim 6, wherein the side walls are integrally formed with the planter base and rigidly attached thereto to form a unified planter base assembly.

8. The top cover system, as set forth in claim 6, wherein the side walls are adapted to releasably attach by one of a press-fitting and snap-fitting the side walls to the perimeter of the planter base.

9. The top cover system, as set forth in claim 6, wherein the perimeter of the top cover is adapted to releasably attach by one of a press-fitting and snap-fitting the perimeter of the top cover to the side walls of the planter base such that when the bag is placed inside the planter base including the side walls and the perimeter of the top cover is attached to the side walls of the planter base, the bag cannot be seen.

10. A top cover system comprising:
a bag including a growing medium;
a first top cover including an opening for placement upon a top side of the bag wherein a perimeter and an area of the opening of the first top cover is of a first geometric shape; and,
a second top cover including one or more openings for placement upon the first top cover wherein a perimeter and an area of the one or more openings of the second top cover is of a second geometric shape and the perimeter and the area of the second top cover is substantially similar to the perimeter and the area of the opening of the first top cover enabling a user to choose between the first geometric shape or the second geometric shape to create one or more openings upon the top side of the bag such that the first top cover or the first top cover in combination with the second top cover regardless of the exercised geometric shape choice of the user when placed upon the top side of the bag hides from view the top side of the bag and a portion of the one or more openings of the top side of the bag and the opening of the first top cover or the one or more openings of the second top cover include access to the growing medium for growing the at least one of a seed and plant.

11. The top cover system, as set forth in claim 10, further including side walls downwardly extending from the perimeter of the first top cover wherein a height of the side walls of the first top cover is greater than a height of the bag laid on its side such that when the first top cover including the side walls is placed upon the bag laid on its side, the bag cannot be seen.

12. The top cover system, as set forth in claim 11, wherein the side walls are integrally formed with the first top cover and rigidly attached thereto to form a unified top cover assembly.

13. The top cover system, as set forth in claim 11, wherein the side walls are adapted to releasably attach by one of a press-fitting and snap-fitting the side walls to the perimeter of the first top cover.

14. The top cover system, as set forth in claim 10, further including a planter base wherein a perimeter and area of the planter base is greater than the perimeter and the area of the bag.

15. The top cover system, as set forth in claim 14, further including side walls upwardly extending from the perimeter of the planter base wherein a height of the side walls of the planter base is greater than a height of the bag laid on its side such that when the bag is placed laid on its side inside the planter base including the side walls, a bottom side of the bag cannot be seen.

16. The top cover system, as set forth in claim 15, wherein the side walls are integrally formed with the planter base and rigidly attached thereto to form a unified planter base assembly.

17. The top cover system, as set forth in claim 15, wherein the side walls are adapted to releasably attach by one of a press-fitting and snap-fitting the side walls to the perimeter of the planter base.

18. The top cover system, as set forth in claim 15, wherein the perimeter of the first top cover is adapted to releasably attach by one of a press-fitting and snap-fitting the perimeter of the first top cover to the side walls of the planter base such that when the bag is placed inside the planter base including the side walls and the perimeter of the top cover is attached to the side walls of the planter base, the bag cannot be seen.

19. A top cover system comprising:
a bag including a growing medium;
a first top cover including an opening for placement upon a top side of the bag; and,
a second top cover including one or more openings for placement upon the first top cover wherein a perimeter and an area of the second top cover is substantially similar to a perimeter and an area of the opening of the first top cover enabling a user to choose one or more shapes to create one or more openings upon the top side of the bag such that the first top cover or the first top cover in combination with the second top cover regardless of the exercised shape choice of the user when placed upon the top side of the bag hides from view the top side of the bag and a portion of the one or more openings of the top side of the bag and the opening of the first top cover or the one or more openings of the second top cover include access to the growing medium for growing the at least one of a seed and plant.

20. The top cover system, as set forth in claim 19, further including side walls downwardly extending from the perimeter of the first top cover wherein a height of the side walls of the first top cover is greater than a height of the bag laid on its side such that when the first top cover including the side walls is placed upon the bag laid on its side, the bag cannot be seen.

21. The top cover system, as set forth in claim 20, wherein the side walls are integrally formed with the first top cover and rigidly attached thereto to form a unified top cover assembly.

22. The top cover system, as set forth in claim 20, wherein the side walls are adapted to releasably attach by one of a press-fitting and snap-fitting the side walls to the perimeter of the first top cover.
